(19) United States
(12) Patent Application Publication
(10) Pub. No.: US 2026/0249624 A1
(43) Pub. Date: Aug. 27, 2026

(54) PRINTING APPARATUS

(71) Applicant: SEIKO EPSON CORPORATION, Tokyo (JP)

(72) Inventor: Yusuke KANNO, SHIOJIRI-SHI (JP)

(21) Appl. No.: 19/549,403

(22) Filed: Feb. 25, 2026

(30) Foreign Application Priority Data
Feb. 27, 2025 (JP) 2025-030709

(51) Int. Cl. B41J 11/00; B41J 29/377

(52) U.S. Cl. CPC B41J 11/0085; B41J 11/007; B41J 29/377

(57) ABSTRACT

A printing apparatus includes: a transport unit that transports a medium in a transport direction; a support unit that supports the medium while attracting the medium by suction via a plurality of suction holes; and a print head that performs printing, the support unit includes a support plate in which the suction holes are formed, a first negative pressure chamber provided on a side opposite to the print head with the support plate interposed therebetween, a second negative pressure chamber that is provided on a side opposite to the print head with the support plate interposed therebetween and is disposed downstream of the first negative pressure chamber in the transport direction, a first/second fan that sucks gas from the first/second negative pressure chamber communicating with a portion of the suction holes, and a suction pressure of a region of the support plate corresponding to the first negative pressure chamber is higher than a suction pressure of a region of the support plate corresponding to the second negative pressure chamber.

The present application is based on, and claims priority from JP Application Serial Number 2025-030709, filed Feb. 27, 2025, the disclosure of which is hereby incorporated by reference herein in its entirety.

### BACKGROUND

### 1. Technical Field

The present disclosure relates to a printing apparatus.

### 2. Related Art

JP-A-2024-115642 discloses a printing apparatus and a printing method which suppress deviation of landing positions of ink. In this printing apparatus, a support unit attracts a print medium by suction via a plurality of suction holes arranged in the transport direction of the print medium. A line print head ejects ink onto the print medium being moved on the support unit by the transport unit. In the case where a first ejection timing is defined as an ejection timing when the leading edge of the print medium in the transport direction is positioned in a first region of the support unit, and a second ejection timing is defined as an ejection timing when the leading edge is positioned in a second region of the support unit positioned downstream of the first region in the transport direction, an ejection timing control unit controls the ejection timing such that the first ejection timing is earlier than the second ejection timing.

In the printing apparatus disclosed in JP-A-2024-115642, there is a possibility that the suction pressure for attracting the print medium is biased depending on the print medium and the dimensions of the support unit, and that the suction pressure required to hold the print medium cannot be obtained at predetermined positions. Hence, in such a printing apparatus, there is a possibility that the number of fans for suction to attract the print medium increases, leading to an increase in cost for suction to attract the print medium.

### SUMMARY

A printing apparatus according to an aspect to solve the above issues includes: a transport unit that transports a print medium in a transport direction; a support unit that supports the print medium while attracting the print medium by suction via a plurality of suction holes; and a print head that is disposed at a position facing the support unit and performs printing by ejecting ink onto the print medium supported by the support unit, the support unit includes a support plate in which the suction holes are formed, a first negative pressure chamber provided on a side opposite to the print head with the support plate interposed therebetween, a second negative pressure chamber that is provided on a side opposite to the print head with the support plate interposed therebetween and is disposed downstream of the first negative pressure chamber in the transport direction, a first fan that sucks gas from the first negative pressure chamber communicating with a portion of the suction holes, and a second fan that sucks gas from the second negative pressure chamber communicating with a portion of the suction holes, and a suction pressure of a region of the support plate corresponding to the first negative pressure chamber is higher than a suction pressure of a region of the support plate corresponding to the second negative pressure chamber.

### BRIEF DESCRIPTION OF THE DRAWINGS

FIG. 1 is a side view schematically illustrating an internal structure of a printing apparatus according to an embodiment of the present disclosure.

FIG. 2 is a plan view schematically illustrating an internal structure of the printing apparatus.

FIG. 3 is a diagram illustrating the suction pressure in each of suction holes of the printing apparatus.

### DESCRIPTION OF EMBODIMENTS

Hereinafter, an embodiment of the present disclosure will be described with reference to the drawings.

In the drawings, a reference sign FR indicates a front side of a printing apparatus 1 in a state where the printing apparatus 1 is installed on an installation surface and is normally used, a reference sign UP indicates an upper side of the printing apparatus 1, and a reference sign LH indicates a left side of the printing apparatus. The front/rear direction and the right/left direction of the printing apparatus 1 coincide with horizontal directions, and the up/down direction coincides with the vertical direction. The directions in the following description are along these directions of the printing apparatus 1.

### Configuration of Printing Apparatus

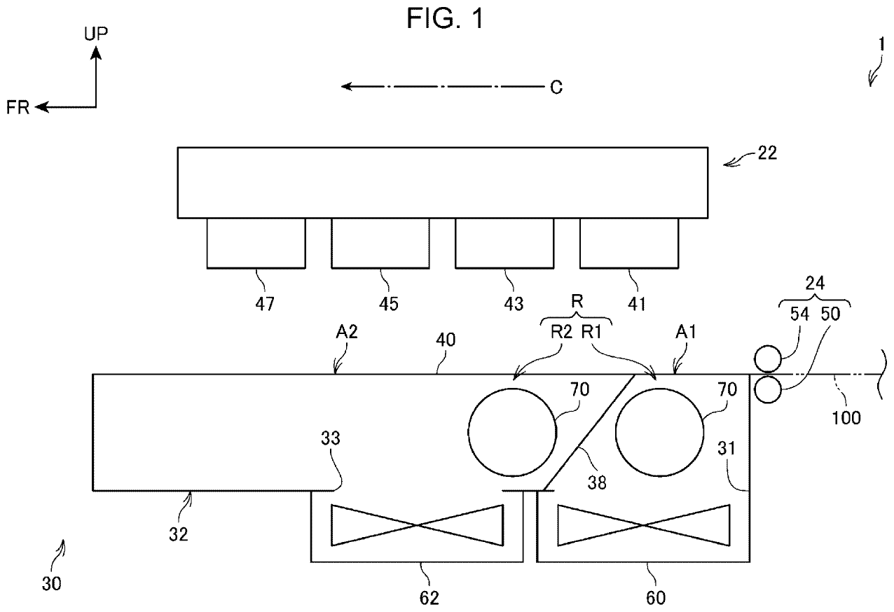

FIG. 1 is a side view schematically illustrating an internal structure of the printing apparatus 1 according to an embodiment of the present disclosure. In FIG. 1, for convenience of description, the transport direction C is indicated by a dashed dotted line, and a print medium 100 is indicated by a dashed double-dotted line.

The printing apparatus 1 illustrated in FIG. 1 is a line ink jet printer which includes a line-shaped ink jet head, discharges ink from the ink jet head, and prints characters and images on the print medium 100 which is transported along the transport direction C.

In the following description, the transport direction C is a direction that is orthogonal to the right/left direction and extends from the rear side toward the front side in the printing apparatus 1.

The print medium 100 used for printing in the printing apparatus 1 is a cut sheet cut into a predetermined size or a continuous sheet. These sheets are formed of paper, plastic, or the like. These sheets may be, for example, fine paper subjected to surface treatment for enhancing ink absorbency and fixability and suitable for ink jet printing.

Examples of continuous sheets include roll paper which is stored in the printing apparatus 1 in a state of being wound in a roll shape, and a fanfold sheet which is supplied to the printing apparatus 1 from the outside of the printing apparatus 1 in a folded state. As roll paper, in addition to a rolled sheet of plain paper or fine paper, a label roll may be used in which labels of a standard size having an adhesive on the rear surface are arranged on release paper serving as a base sheet and wound in a roll shape.

The printing apparatus 1 includes a print unit 22 that performs printing on the print medium 100. The print unit 22 includes a print head 42. The print head 42 of the present embodiment ejects ink of four colors of C (cyan), M (magenta), Y (yellow), and K (black) to form dots on the print surfaces of labels. The print head 42 is provided with a nozzle portion 41 that ejects K (black) ink, a nozzle portion 43 that ejects C (cyan) ink, a nozzle portion 45 that ejects M (magenta) ink, and a nozzle portion 47 that ejects Y (yellow) ink. In the nozzle portions 41 to 47, a plurality of nozzles which eject ink are arranged in rows in the width direction of the print medium 100. The nozzles included in the nozzle portions 41 to 47 are arranged along a direction intersecting the transport direction C.

The print head 42 is a line ink jet head capable of ejecting ink in the width direction of the print medium 100 without scanning. Therefore, the nozzle rows of the nozzle portions 41 to 47 are formed to have a width at least equal to or wider than the printable range of the print medium 100. In the present embodiment, the printable range corresponds to the printing surfaces of the labels.

In the embodiment, although a configuration example in which the nozzle portions 41, 43, 45, and 47 are arranged in this order along the transport direction C of the print medium 100 is described, the arrangement order of the nozzles of each color in the transport direction C is not particularly limited.

In the printing apparatus 1, a support unit 30 is provided under the print unit 22. The support unit 30 includes a box-shaped support unit housing 32 having a space R inside and a platen 40, which is a flat surface, on its upper surface.

The platen 40 is positioned on the lower side of the print medium 100 being transported, and faces the print head 42. The nozzle portions 41 to 47 and the platen 40 are disposed with an interval, which is a so-called platen gap, therebetween.

The platen 40 supports the print medium 100 from below. The platen 40 is provided to extend at least over the entire printing range of the print unit 22. The flat surface of the platen 40 is arranged substantially horizontally in the installation state and the use state of the printing apparatus 1.

A transport unit 24 is provided at a rear end portion of the support unit 30. The transport unit 24 includes a cylindrical transport roller 50. The transport roller 50 is disposed such that its longitudinal direction extends along a direction orthogonal to the transport direction C, and is provided rotatably in the circumferential direction. The transport roller 50 is disposed at a rear end portion of the platen 40. The transport roller 50 is provided with a transport motor serving as a driving device for rotationally driving the transport roller 50.

The transport unit 24 includes a plurality of paper feed driven rollers 54. The plurality of paper feed driven rollers 54 are rotatably arranged along the longitudinal direction of the transport roller 50. The paper feed driven rollers 54 are all urged so that their peripheral surfaces are brought into contact with the peripheral surface of the transport roller 50. Accordingly, the transport roller 50 and the paper feed driven rollers 54 are arranged to face each other.

In the transport unit 24, when the transport motor is driven, the transport roller 50 is driven to rotate, and the paper feed driven rollers 54 are driven to rotate. The print medium 100 is pinched between the transport roller 50 and the paper feed driven rollers 54, and is transported between the print unit 22 and the support unit 30 along with the rotational driving of the transport roller 50.

When the print medium 100 is transported to the print unit 22, printing is performed on the print medium 100 by the print unit 22. Thereafter, the print medium 100 is discharged to the outside of the printing apparatus 1 by the driving of the transport unit 24.

### Configuration of Support Unit

In the support unit 30, a first ventilation opening 31 and a second ventilation opening 33, which are openings for connecting the inside and the outside of the support unit housing 32, are provided in bottom portions of the support unit housing 32. The first ventilation opening 31 and the second ventilation opening 33 are provided along the transport direction C, and the first ventilation opening 31 is positioned upstream of the second ventilation opening 33 in the transport direction C. In the present embodiment, both the first ventilation opening 31 and the second ventilation opening 33 are disposed substantially at the center of the support unit housing 32 in the right/left direction.

The first ventilation opening 31 is covered by a first fan 60 from the outside of the support unit housing 32. The second ventilation opening 33 is covered by a second fan 62 from the outside of the support unit housing 32. The first fan 60 is a fan that is driven to suck air from the space R of the support unit housing 32 through the first ventilation opening 31 and blow the air to the outside. The second fan 62 is a fan that is driven to suck air from the space R of the support unit housing 32 through the second ventilation opening 33 and blow the air to the outside. Various fans such as axial flow fans and centrifugal fans may be used as the first fan 60 and the second fan 62.

In the present embodiment, the first fan 60 and the second fan 62 have substantially the same performance. Specifically, the first fan 60 and the second fan 62 have substantially the same airflow rate-static pressure characteristics. Therefore, in the printing apparatus 1, it is possible to use substantially the same type of fans regardless of the arrangement position. Therefore, in the printing apparatus 1, it is possible to suppress an increase in cost for holding the print medium.

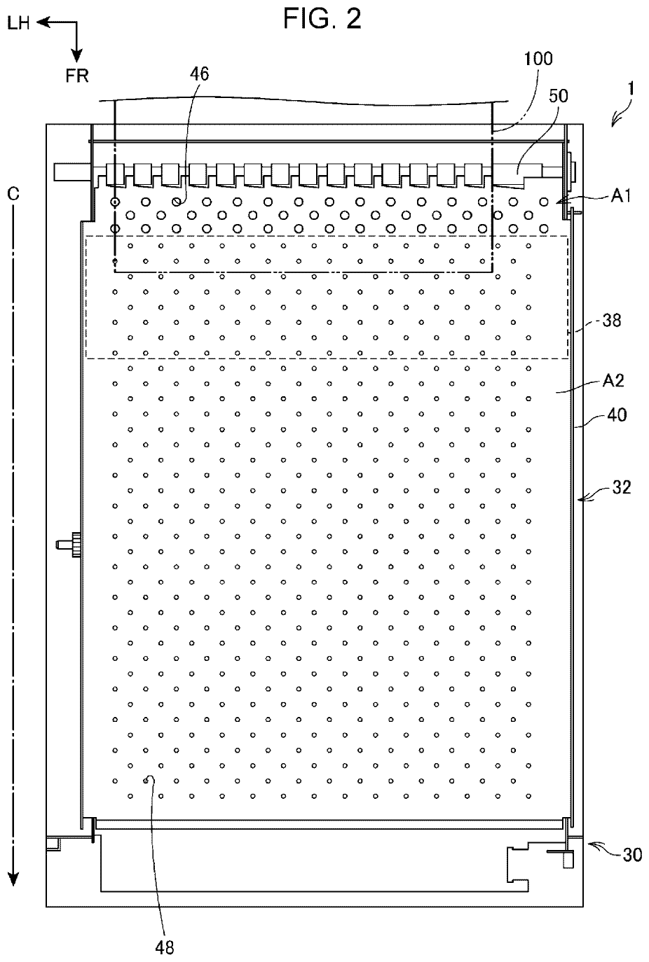

FIG. 2 is a plan view schematically illustrating an internal structure of the printing apparatus 1. In FIG. 2, for convenience of description, the transport direction C is indicated by a dashed dotted line, and the print medium 100 is indicated by dashed double-dotted lines.

As illustrated in FIG. 2, the platen 40 is provided with a plurality of first suction holes 46 and a plurality of second suction holes 48. Each of the plurality of first suction holes 46 and the plurality of second suction holes 48 is a through hole extending through the platen 40 in the thickness direction. In the present embodiment, in a plan view, the opening area of each of the first suction holes 46 is formed to be larger than the opening area of each of the second suction holes 48.

In the printing apparatus 1, when the first fan 60 and the second fan 62 are rotationally driven, air is sucked from the space R of the support unit housing 32, and air outside the support unit housing 32 is sucked into the support unit housing 32 through the plurality of first suction holes 46 and the plurality of second suction holes 48.

As a result, the print medium 100 being transported by the transport unit 24 is attracted to the platen 40 and held so as not to be separated from the platen 40 while being transported. Therefore, it is possible to perform printing while suppressing a decrease in printing accuracy in the print unit 22.

In a plan view of the platen 40, the first suction holes 46 are arranged at predetermined intervals at positions adjacent to the transport roller 50, and spaced from the edge portions of the platen 40 by predetermined distances.

In the platen 40, the second suction holes 48 are arranged at predetermined intervals on the front side of the region where the first suction holes 46 are arranged, in other words, downstream in the transport direction, and spaced from the edge portions of the platen 40 by predetermined distances.

In the following description, the region where the first suction holes 46 are arranged is referred to as an attraction region A1, and the region where the second suction holes 48 are arranged is referred to as a holding region A2.

In the attraction region A1, the print medium 100 being transported by the transport unit 24 is attracted to the platen 40. Therefore, in the attraction region A1 of the platen 40, air outside the support unit housing 32 is sucked into the support unit housing 32 via the first suction holes 46 with a suction pressure, in other words, a static pressure, higher than that in the other region, that is, the holding region A2.

The total value S1 of the opening areas of the first suction holes 46 in the attraction region A1 is expressed by the following Formula (1).

$$S 1 \leq Q 1 / ( √ ( 2 \times P 1 / ρ1 ) ) \qquad ( 1 )$$

In Formula (1), Q1 is an airflow rate output by the first fan 60 when the first fan 60 outputs a static pressure required to attract the print medium 100 being transported by the transport unit 24 to the platen 40 in the attraction region A1. This airflow rate can be obtained from the static pressure-airflow rate characteristics provided by a fan manufacturer or the like based on the static pressure of the fan. P1 is a static pressure required to attract the print medium 100 being transported by the transport unit 24 to the platen 40, and is a value obtained by an experiment or the like conducted in advance. The symbol ρ1 denotes the density of the air sucked by the first fan 60.

In the platen 40, in accordance with the total value S1 obtained by Formula (1), the first suction holes 46 having opening areas that satisfy the total value S1 and the attraction region A1 are formed.

In the present embodiment, each of the first suction holes 46 is formed in a circular shape having a diameter of 4.0 mm in a plan view. The first suction holes 46 are arranged in the platen 40 at equal intervals of 9 mm or less.

In the attraction region A1, the print medium 100 being transported by the transport unit 24 is attracted to the platen 40. Therefore, in the attraction region A1 of the platen 40, air outside the support unit housing 32 is sucked into the support unit housing 32 via the first suction holes 46 with a suction pressure, in other words, a static pressure, higher than that in the other region, that is, the holding region A2.

In a case where the entire attraction region A1 is covered with the print medium 100 in a plan view, the suction pressure of the attraction region A1 is made equal to or higher than the suction pressure at which the print medium 100 can be attracted, by the total value S1 and the airflow rate output by the first fan 60 mentioned above.

Accordingly, in the printing apparatus 1, it is possible to attract and hold each print medium 100 which can be set on the platen 40.

The total value S2 of the opening areas of the second suction holes 48 in the holding region A2 is expressed by the following Formula (2), similarly to the total value S1.

$$S 2 \leq Q 2 / ( √ ( 2 \times P 2 / ρ2 ) ) \qquad ( 2 )$$

In Formula (2), Q2 is an airflow rate output by the second fan 62 when the second fan 62 outputs a static pressure required to hold the print medium 100 being transported by the transport unit 24 on the platen 40 in the holding region A2. This airflow rate can be obtained from the static pressure-airflow rate characteristics provided by a fan manufacturer or the like based on the static pressure of the fan. P2 is a static pressure required to hold the print medium 100 being transported by the transport unit 24 on the platen 40, and is a value obtained by an experiment or the like conducted in advance. The symbol ρ2 denotes the density of the air sucked by the second fan 62.

In the platen 40, in accordance with the total value S2 obtained by Formula (2), the second suction holes 48 having opening areas that satisfy the total value S2 and the holding region A2 are formed.

In the present embodiment, each of the second suction holes 48 is formed in a circular shape having a diameter of 1.5 mm in a plan view, and the second suction holes 48 are arranged in the platen 40 at equal intervals of 9 mm or less.

In a case where the entire holding region A2 is covered with the print medium 100 in a plan view, the suction pressure of the holding region A2 is made equal to or higher than the suction pressure at which the print medium 100 can be attracted, by the total value S2 and the airflow rate output by the second fan 62 mentioned above.

Accordingly, in the printing apparatus 1, it is possible to attract and hold each print medium 100 which can be set on the platen 40.

As illustrated in FIGS. 1 and 2, the support unit housing 32 is provided with a partition member 38 for partitioning the internal space R. The partition member 38 is formed in a plate shape, with its flat surfaces facing the front side and the rear side. An upper end portion of the partition member 38 is connected to the platen 40, and a lower end portion thereof is connected to a bottom portion of the support unit housing 32. Left and right end portions of the partition member 38 are connected to left and right side surfaces of the support unit housing 32, respectively. Thus, the partition member 38 partitions the space R into front and rear portions. In other words, the partition member 38 partitions the space R into an upstream portion and a downstream portion in the transport direction C.

In the following description, the space partitioned by the partition member 38 and positioned upstream in the transport direction C is referred to as an attraction space R1, and the space partitioned by the partition member 38 and positioned downstream in the transport direction C is referred to as a holding space R2.

In a plan view of the platen 40, the upper end portion of the partition member 38 is disposed between the attraction region A1 and the holding region A2. In a plan view of the platen 40, the lower end portion of the partition member 38 is disposed between the first ventilation opening 31 and the second ventilation opening 33.

Thus, each of the first suction holes 46 and the first ventilation opening 31 communicate with the attraction space R1, and each of the second suction holes 48 and the second ventilation opening 33 communicate with the holding space R2.

As illustrated in FIG. 1, a shutter mechanism 70 is provided in each of the attraction space R1 and the holding space R2. Each of the shutter mechanisms 70 is driven to open and close at least a portion of the first suction holes 46 or the second suction holes 48. In the present embodiment, each of the shutter mechanisms 70 is provided to extend across the entire platen 40 in the right/left direction. Each of the shutter mechanisms 70 is capable of opening and closing each of the first suction holes 46 or the second suction holes 48 in order from the right to the left at the position where the shutter mechanism 70 is provided.

The present disclosure is not limited to this, and each of the shutter mechanisms 70 may be capable of opening and closing each of the first suction holes 46 or the second suction holes 48 in order from both left and right end portions toward substantially the center in the right/left direction at the position at which the shutter mechanism 70 is provided.

### Operation of Printing Apparatus

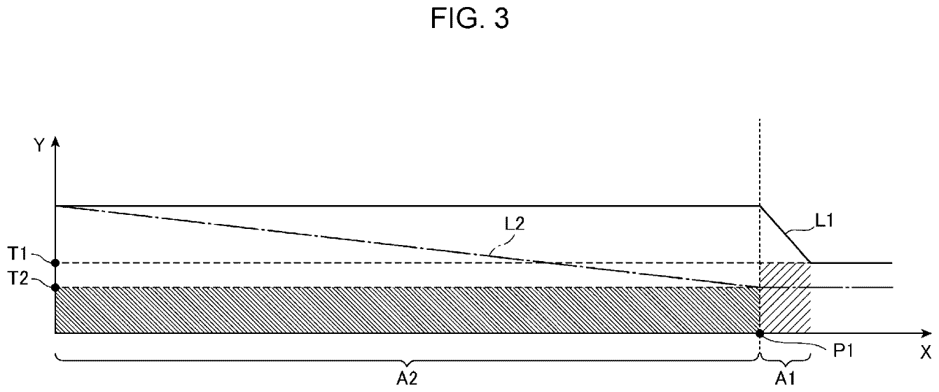

FIG. 3 is a diagram illustrating the relationship between the position of the leading end portion of the print medium 100 on the platen 40 and the suction pressure in each of the first suction holes 46 and the second suction holes 48. In FIG. 3, the horizontal axis X indicates the position of the leading end portion of the print medium 100. On the horizontal axis X, the origin corresponds to the position of the downstream end of the platen 40, and as the distance from the origin increases, the distance to the transport unit 24 decreases. The vertical axis Y indicates the suction pressure in each of the first suction holes 46 and the second suction holes 48.

In FIG. 3, the point P1 indicates the position at which the upper end portion of the partition member 38 is connected to the platen 40 between the attraction region A1 and the holding region A2. A diagonally upward-to-the-right hatched region indicates the suction pressure required to attract the print medium 100 to the platen 40 in the attraction region A1, and the point T1 indicates the value of the suction force. A diagonally downward-to-the-right hatched region indicates the suction pressure required to hold the print medium 100 attracted to the platen 40 on the platen 40 in the holding region A2, and the point T2 indicates the value of the suction pressure.

In FIG. 3, the solid line L1 indicates the suction pressure of the first suction holes 46 that changes along with the transport of the print medium 100, and the dashed dotted line L2 indicates the suction pressure of the second suction holes 48 that changes along with the transport of the print medium 100.

When the print medium 100 is transported to the print unit 22, printing is performed on the print medium 100 by the print unit 22. In this process, the print medium 100 is attracted to the platen 40 by suction of the first suction holes 46, and is held on the platen 40 by suction of the second suction holes 48.

As illustrated in FIG. 3, a higher suction pressure is required in the attraction region A1 than in the holding region A2.

In the present embodiment, the partition member 38 that partitions the internal space R is provided in the support unit housing 32. As a result, the first fan 60 sucks air from the first suction holes 46. Hence, as illustrated in FIG. 3, in the attraction region A1, it is possible to obtain a suction pressure required to attract the print medium 100 to the platen 40.

Similarly, the second fan 62 sucks air from the second suction holes 48. Hence, as illustrated in FIG. 3, in the holding region A2, it is possible to obtain a suction pressure required to hold the print medium 100 on the platen 40.

Accordingly, in the printing apparatus 1, it is possible to attract and hold the print medium 100 without excessively increasing the performance and the number of fans. Therefore, in the printing apparatus 1, it is possible to improve the printing accuracy while suppressing an increase in cost for holding the print medium 100.

The above-described embodiment is merely illustrative of one aspect of the present disclosure, and various modifications and applications may be made as appropriate without departing from the spirit of the present disclosure.

In the embodiment described above, the first suction holes 46 are provided in the attraction region A1, and the second suction holes 48 are provided in the holding region A2. However, the present disclosure is not limited thereto, and a portion of the second suction holes 48 may be disposed in the attraction region A1 as long as Formulae (1) and (2) are satisfied.

In the above-described embodiment, the platen 40 serves as the upper surface of the support unit housing 32. However, the present disclosure is not limited thereto, and the platen 40 may be formed in any manner as long as the space communicating with the attraction region A1 and the space communicating with the holding region A2 are different spaces. For example, the platen 40 may be formed on an upper surface of a first housing in which a space communicating with the attraction region A1 is provided and an upper surface of a second housing in which a space communicating with the holding region A2 is provided.

In the above-described embodiment, the first fan 60 and the second fan 62 have substantially the same performance. However, the present disclosure is not limited thereto, and the fans may have different performances as long as the suction pressure required to attract the print medium 100 being transported by the transport unit 24 to the platen 40 and the suction pressure required to hold the print medium 100 attracted to the platen 40 on the platen 40 are satisfied.

Unless otherwise specified, directions such as horizontal and vertical directions, numerical values, and various shapes in the above-described embodiment include equivalent ranges that provide the same effects as the directions, numerical values, and shapes.

### Summary of Present Disclosure

The following describes a summary of the present disclosure.

### Appendix 1

A printing apparatus including: a transport unit that transports a print medium in a transport direction; a support unit that supports the print medium while attracting the print medium by suction via a plurality of suction holes; and a print head that is disposed at a position facing the support unit and performs printing by ejecting ink onto the print medium supported by the support unit, in which the support unit includes a support plate in which the suction holes are formed, a first negative pressure chamber provided on a side opposite to the print head with the support plate interposed therebetween, a second negative pressure chamber that is provided on a side opposite to the print head with the support plate interposed therebetween and is disposed downstream of the first negative pressure chamber in the transport direction, a first fan that sucks gas from the first negative pressure chamber communicating with a portion of the suction holes, and a second fan that sucks gas from the second negative pressure chamber communicating with a portion of the suction holes, and a suction pressure of a region of the support plate corresponding to the first negative pressure chamber is higher than a suction pressure of a region of the support plate corresponding to the second negative pressure chamber.

Accordingly, in the printing apparatus, the print medium can be attracted and held without excessively increasing the performance and the number of fans. Therefore, in the printing apparatus, it is possible to improve the printing accuracy while suppressing an increase in cost for holding the print medium.

### Appendix 2

The printing apparatus according to technique 1, in which when a print medium having the largest width dimension in a direction intersecting the transport direction, among print media that can be supported by the support plate, reaches the region of the support plate corresponding to the first negative pressure chamber, the suction pressure of the region of the support plate corresponding to the first negative pressure chamber is equal to or higher than a pressure at which the print medium having the largest width dimension is attracted to the support plate.

Accordingly, in the printing apparatus, it is possible to improve the printing accuracy while suppressing an increase in cost for holding the print medium.

### Appendix 3

The printing apparatus according to technique 1 or 2, in which when the print medium having the largest width dimension in the direction intersecting the transport direction, among the print media that can be supported by the support plate, reaches the region of the support plate corresponding to the second negative pressure chamber, the suction pressure of the region of the support plate corresponding to the second negative pressure chamber is equal to or higher than a pressure at which the print medium having the largest width dimension is held on the support plate.

This enables the printing apparatus to attract and hold each print medium that can be set on the platen.

### Appendix 4

The printing apparatus according to any one of techniques 1 to 3, in which

$$S 1 \leq Q 1 / ( √ ( 2 \times P 1 / ρ1 ) ) holds ,$$

where S1 represents an opening area of a portion of the suction holes in the region of the support plate corresponding to the first negative pressure chamber, Q1 represents an airflow rate of the first fan, P1 represents a static pressure of the first fan, and ρ1 represents a density of gas sucked by the first fan.

Accordingly, in the printing apparatus, it is possible to improve the printing accuracy while suppressing an increase in cost for holding the print medium.

### Appendix 5

The printing apparatus according to any one of techniques 1 to 4, in which

$$S 2 \leq Q 2 / ( √ ( 2 \times P 2 / ρ2 ) ) holds ,$$

where S2 represents an opening area of a portion of the suction holes in the region of the support plate corresponding to the second negative pressure chamber, Q2 represents an airflow rate of the second fan, P2 represents a static pressure of the second fan, and ρ2 represents a density of gas sucked by the second fan.

Accordingly, in the printing apparatus, it is possible to improve the printing accuracy while suppressing an increase in cost for holding the print medium.

### Appendix 6

The printing apparatus according to any one of techniques 1 to 5, in which the first fan and the second fan have substantially the same suction performance.

Accordingly, in the printing apparatus, it is possible to improve the printing accuracy while suppressing an increase in cost for holding the print medium.

What is claimed is:

1. A printing apparatus comprising:
a transport unit that transports a print medium;
a support unit that supports the print medium while attracting the print medium by suction via a plurality of suction holes; and
a print head that is disposed at a position facing the support unit and performs printing by ejecting ink onto the print medium supported by the support unit, wherein
the support unit includes
a support plate in which the suction holes are formed,
a first negative pressure chamber provided on a side opposite to the print head with the support plate interposed therebetween,
a second negative pressure chamber that is provided on a side opposite to the print head with the support plate interposed therebetween and is disposed downstream of the first negative pressure chamber in a transport direction of the print medium,
a first fan that sucks gas from the first negative pressure chamber communicating with the suction holes, and
a second fan that sucks gas from the second negative pressure chamber communicating with the suction holes, and
a suction pressure of a region of the support plate corresponding to the first negative pressure chamber is higher than a suction pressure of a region of the support plate corresponding to the second negative pressure chamber.

2. The printing apparatus according to claim 1, wherein
when a print medium having the largest width dimension in a direction intersecting the transport direction, among print media that can be supported by the support plate, reaches the region of the support plate corresponding to the first negative pressure chamber, the suction pressure of the region of the support plate corresponding to the first negative pressure chamber is equal to or higher than a pressure at which the print medium having the largest width dimension is attracted to the support plate.

3. The printing apparatus according to claim 2, wherein
when the print medium having the largest width dimension in the direction intersecting the transport direction, among the print media that can be supported by the support plate, reaches the region of the support plate corresponding to the second negative pressure chamber, the suction pressure of the region of the support plate corresponding to the second negative pressure chamber is equal to or higher than a pressure at which the print medium having the largest width dimension is held on the support plate.

4. The printing apparatus according to claim 1, wherein
$$S 1 \leq Q 1 / ( √ ( 2 \times P 1 / ρ1 ) ) holds ,$$
where S1 represents an opening area of the suction holes in the region of the support plate corresponding to the first negative pressure chamber, Q1 represents an airflow rate of the first fan, P1 represents a static pressure of the first fan, and ρ1 represents a density of gas sucked by the first fan.

5. The printing apparatus according to claim 4, wherein
$$S 2 \leq Q 2 / ( √ ( 2 \times P 2 / ρ2 ) ) holds ,$$
where S2 represents an opening area of the suction holes in the region of the support plate corresponding to the second negative pressure chamber, Q2 represents an airflow rate of the second fan, P2 represents a static pressure of the second fan, and ρ2 represents a density of gas sucked by the second fan.

6. The printing apparatus according to claim 5, wherein
the first fan and the second fan have substantially the same suction performance.
